(19) United States
(12) Patent Application Publication
(10) Pub. No.: US 2017/0036120 A1
(43) Pub. Date: Feb. 9, 2017

(54) Interactive Multiplayer Online Gaming System and Method

(71) Applicant: Knittel Ventures, LLC, San Jose, CA (US)

(72) Inventor: David Knittel, San Jose, CA (US)

(73) Assignee: Knittel Ventures, LLC, San Jose, CA (US)

(21) Appl. No.: 15/226,135

(22) Filed: Aug. 2, 2016

Related U.S. Application Data
(60) Provisional application No. 62/200,603, filed on Aug. 3, 2015.

(51) Int. Cl. A63F 13/828; A63F 13/87; A63F 13/216; G07F 17/32; A63F 13/32; A63F 13/33; A63F 13/20; A63F 13/46

(52) U.S. Cl. CPC A63F 13/828; A63F 13/20; A63F 13/87; A63F 13/46; G07F 17/3244; G07F 17/323; G07F 17/3288; G07F 17/3276; A63F 13/32; A63F 13/33; A63F 13/216

(57) ABSTRACT

Disclosed is a system and method for drafting and scoring fantasy sports. One embodiment of the system includes a game application that enables users to draft sports teams for a particular sports game in order to enter a competition, the competition having parameters set by a fantasy owner. Real-time data is used to calculate fantasy points for each team drafted by the users, and the fantasy points are consolidated for each user upon completion of the competition in order to determine final competition standing for each user. The final competition standing is used for allocating winnings and losses and for updating a leaderboard.

### CROSS-REFERENCE TO RELATED APPLICATIONS

This application claims the benefit of U.S. Provisional Patent Application No. 62/200,603, filed Aug. 3, 2015, which is hereby incorporated by reference in its entirety.

### FIELD OF THE INVENTION

The present invention generally relates to a system and method for interactive online play. More particularly, the present invention is directed to an online gaming application for fantasy sports.

### BACKGROUND OF THE INVENTION

Various types of game applications for playing online fantasy sports are known in the art. These game applications generally require a user to form a sports team by drafting real-life active players in order to enter into a competition. In this way, existing online fantasy sports games utilize live player statistics for each of the individual players in order to conduct scoring and determine a winner in the competition.

The existing systems and methods for fantasy sports comprise complicated elements of drafting teams, setting lineups, and scoring. For example, the existing systems and methods for fantasy sports do not allow users to draft an entire team or a club. In other words, current applications do not allow users to draft players in a collective manner because of a salary cap or other types of restrictions or rules. Thus, users are unable to draft their favorite teams or best performing teams in a competition, and the collective performance of a team does not count as a single entity. Therefore, it is difficult, confusing, and frustrating for many casual fans or users to partake in fantasy sports. In this regard, the invention described herein addresses this problem.

### SUMMARY OF THE INVENTION

In view of the disadvantages inherent in the known types of systems and methods for fantasy sports now present in the prior art, the present invention provides an improved system and method of fantasy sports drafting and scoring.

The following discloses a simplified summary of the specification in order to provide a basic understanding of some aspects of the specification. This summary is not an extensive overview of the specification. It is intended to neither identify key or critical elements of the specification nor delineate the scope of the specification. Its sole purpose is to disclose some concepts of the specification in a simplified form as a prelude to the more detailed description that is disclosed later.

Some embodiments of the system include a memory unit having instructions stored thereon, and a processor operatively connected to the memory unit, wherein the processor is configured to execute the instructions, resulting in a fantasy sport game application. In one embodiment, the game application comprises a website, a web application, a mobile application, a plug-in software, or other types of downloadable or non-downloadable software. The game application comprises an interactive user interface for enabling users to interact with one or more components of the present system as described herein.

The game application is accessible to users via network-enabled user devices (e.g., a computer) to allow the users to interact with one another. The game application allows a user to draft professional sports teams to set lineups. The number of teams selected depends on the type of sports played in a competition. The user's final competition standing is determined by combining the total number of fantasy points of the user's squad entered in the competition. Based on the user's competition standing, the user is allocated winnings or losses and moved up or down on the leaderboard.

Some embodiments include a method for enabling a user to draft sports teams and setting lineups for competitions. The method includes: providing a salary cap, wherein the salary cap may be a preset value for an existing competition or a value determined by a user that is the creator of the competition; selecting at least one team to enter into the competition, wherein each time a team is selected, a cost that is associated with the selected team is automatically deducted from the salary cap; and selecting a formation by selecting one formation from a set of formations provided, wherein each formation is associated with specific lineups, thus enabling the user to lineup teams in accordance with a selected formation without error.

Another embodiment includes enabling a user to use a game application on a computer system to play fantasy sports and increase in ranking on a leaderboard in addition to obtaining points or virtual currency. The method includes: receiving team lineups for each user in a competition; receiving real-time team performance/game data corresponding with each of the teams in the competition; awarding or deducting fantasy points for each team associated with each user in the competition; combining the fantasy points to determine a final competition standing for each user; allocating winnings and/or losses; and updating a leaderboard.

It is therefore an objective of the present system and method to provide an online fantasy sport game application that enables scoring based on an overall team performance rather than based on individual players' performances.

It is another objective of the present system and method to provide an online fantasy sport game application that is configured to draft teams and score in a collective manner, simplifying the process playing fantasy sports.

It is another objective of the present system and method to provide an online fantasy sport game application that is suitable for play with various types of sports.

In the light of the foregoing, these and other objectives are accomplished in accordance of the principles of the present invention, wherein the novelty of the present invention will become apparent from the following detailed description and appended claims.

### BRIEF DESCRIPTION OF THE DRAWINGS

The above and other objects and advantages of the present invention will be apparent upon consideration of the following detailed description, taken in conjunction with the accompanying exemplary drawings, in which like reference characters refer to like parts throughout, and in which:

FIG. 1 is a general architecture of an exemplary embodiment of the present system.

FIG. 2 is a simplified view of an exemplary user interface of the present system.

FIG. 3 is a block diagram of an exemplary computer system within which a set of instructions, for causing the computer system to perform any one or more of the methods discussed herein, may be executed.

FIGS. 4A and 4B show flow diagrams of the main process steps for utilizing the computer system of FIGS. 1 through 3.

### DETAILED DESCRIPTION OF THE INVENTION

The present invention is directed towards a system and method of fantasy sports drafting and scoring. For purposes of clarity, and not by way of limitation, illustrative views of the present system and method are described with references made to the above-identified figures. Various modifications obvious to one skilled in the art are deemed to be within the spirit and scope of the present invention.

As used in this application, the terms “component,” “module,” “system,” “interface,” or the like are generally intended to refer to a computer-related entity, either hardware or a combination of hardware and software. For example, a component can be, but is not limited to being, a process running on a processor, an object, and/or a computer. By way of illustration, both an application running on a controller and the controller can be a component. One or more components can reside within a process and/or thread of execution and a component can be localized on one computer and/or distributed between two or more computers. As another example, an interface can include I/O components as well as associated processor, application, and/or API components.

It is to be appreciated that determinations or inferences referenced throughout the subject specification can be practiced through the use of artificial intelligence techniques. In this regard, some portions of the following detailed description are presented in terms of algorithms and symbolic representations of operations on data bits or binary digital signals within a computer memory. These algorithmic descriptions and representations may be the techniques used by those skilled in the data processing arts to convey the substance of their work to others skilled in the art.

Furthermore, the claimed subject matter can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, or media.

Discussions herein utilizing terms such as, for example, “processing,” “computing,” “calculating,” “determining,” “establishing,” “identifying,” “analyzing,” “checking,” or the like, may refer to operations(s) and/or process(es) of a computer, a computing platform, a computing system, or other electronic computing device, that manipulate and/or transfer data represented as physical (e.g., electronic) quantities within the computer's registers and/or memories into other data similarly represented as physical quantities within the computer's registers and/or memories or other information storage medium that may store instructions to perform operations and/or processes.

Some embodiments of the present invention may include one or more wired or wireless links, may utilize one or more components of wireless communication, may utilize one or more methods or protocols of wireless communication, or the like. Some embodiments may utilize wired communication and/or wireless communication.

Some embodiments may be used in conjunction with various devices and systems, for example, a personal computer (PC), a desktop computer, a mobile computer, a laptop, a tablet computer, a server computer, a handheld device, a personal digital assistant (PDA), a wireless communication device, a smart phone, a non-portable device, a wireless access point (AP), a wired or wireless router, a wired or wireless modem, a wired or wireless network, a local area network (LAN), a wireless LAN (WLAN), a metropolitan area network (MAN), a wireless MAN (WMAN), a wide area network (WAN), a wireless WAN (WWAN), a personal area network (PAN), a wireless PAN (WPAN), or networks operating in accordance with existing and/or future versions and/or derivatives of long term evolution (LTE), a device which incorporates a global positioning system (GPS) receiver or transceiver or chip, a device which incorporates an RFID element or chip, a multiple input multiple output (MIMO) transceiver or device, a single input multiple output (SIMO) transceiver or device, a multiple input single output (MISO) transceiver or device, a device having one or more internal antennas and/or external antennas, or the like.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to disclose concepts in a concrete fashion. As used in this application, the term “or” is intended to mean an inclusive “or” rather than an exclusive “or.” Additionally, the articles “a” and “an” as used in this application and the appended claims should generally be construed to mean “one or more” unless specified otherwise or clear from context to be directed to a singular form.

As used herein, the terms “squad(s),” “team(s),” and/or “club(s),” are used interchangeably unless the context clearly suggests otherwise. Similarly, the terms “user(s),” “end user(s),” “player(s),” “fantasy owner(s),” “participant(s),” and/or “fantasy player(s)” are used interchangeably unless the context clearly suggests otherwise. Finally, the terms “match(es),” “game(s),” “fantasy competition(s),” and/or “competition(s)” are used interchangeably unless the context clearly suggests otherwise.

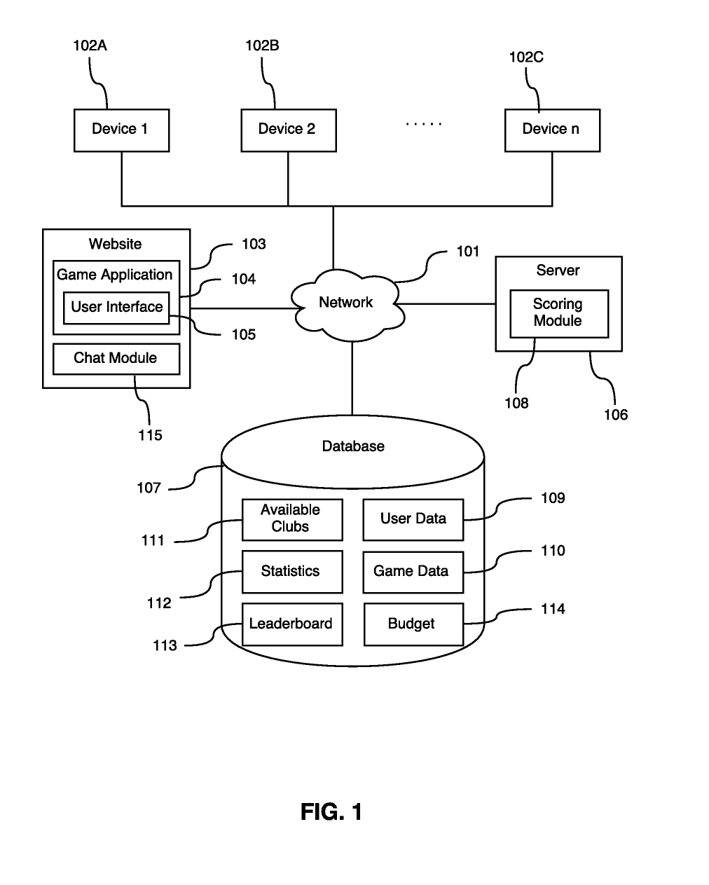

Referring now to FIG. 1, there is shown a view of the exemplary architecture of the present system in a schematic diagram format. The system includes a plurality of user devices 102A-102C and at least one server 106 connected to a network 101 (e.g., Internet, LAN, etc.). Each of the user devices 102A-102C and the server 106 comprises various types of electronic devices. Without limitation, the devices comprise various types of computer systems such as a mobile phone, a computer tablet, a laptop, a desktop, and a personal digital assistant (PDA).

The user devices 102A-102C are configured to access a web application, a mobile application, a website 103, or a plug-in software on which a downloadable or non-downloadable game application 104 is available. For the purposes of illustration, the illustrated embodiment in FIG. 1 shows a website 103. The game application 104 is supported, managed, and maintained through the server 106. The game application 104 comprises user interface 105. The user interface 105 facilitates communication between the user devices 102A-102C and hence the end users operating the user devices 102A-102C and one or more elements of the present system. Without limitation, the user interface 105 may be configured to allow users to enter commands, to input and output information, enter/leave competition, select formations, set lineups, communicate with other users, and the like.

In some embodiments, the game application 104 is configured to enable a user to sign up and create a user account, via the user interface 105, whereby the user is a fantasy game player. The user can create an account by providing his or her name, contact information, such as an email address, avatar, picture, billing information, username and password, and the like. Information related to the user account, including each user's virtual currency or points, is stored as user data 109 in a database 107.

The game application 104 is further configured to enable the user to enter a competition and draft teams or clubs in order to play a fantasy sport. In this regard, the application 104 enables the user to join one or more existing competitions (i.e., created by another user) or create his or her own competition (i.e., as a fantasy owner). To create a new competition, the user can set parameters for the competition, for example, by specifying: the league name; the minimum and maximum number of participants; the salary cap; the duration of the game; the start time; the entry fee requirement; and the prize structure or reward mechanism. It is contemplated that each fantasy competition comprises a sufficient number of participants or users in order to reduce the chances of two or more users selecting the same lineup. The user interface 105 comprises, without limitation, drop down menus, free-text data entry boxes, scales, active links, or any combination thereof for enabling users to set the parameters.

The user can also specify whether the game is a public or a private game. If the game is private, the user can invite other users by, for example, providing other users' email addresses. Once email addresses are provided, the application 104 is configured to automatically send an email to the invitees using API or other suitable means. It is contemplated that the email contains a link to the competition or a token for entering the competition in a secure manner. The invitees must also comprise user accounts for the game application 104 in order to join the competition to which the invitees were invited. If an invitee does not have a user account, the invitee is prompted to create an account, upon activating the link or the token to the competition, before continuing and joining the competition. Data associated with each of the competitions (i.e., ongoing competitions, open competitions, closed competitions, expired competitions, archived competitions, etc.), such as a list or a roster of users, scoring, teams entered in the competitions, are stored as game data 110 in the database 107.

To join a competition, the application 104 is configured to populate available clubs or teams from a bank of available clubs 111 and display the available clubs or teams via the user interface 105. The user can select one or more of the available clubs 111 to draft clubs or teams therefrom, for example, by activating a link or an icon correlating to the respective club or team. In some embodiments, the application 104 may be configured to grey out selected teams such that the user is unable to select teams that were already selected by other users or that were already selected by the user. By drafting clubs or teams instead of individual players, the user only need to follow the scores of the selected clubs or teams to determine his or her fantasy score. Thus, the present system not only simplifies the drafting process, but also the scoring process.

During the drafting process, the user can also view statistics 112 (e.g., real-time statistics, season statistics, etc.) correlating to each of the available clubs or team by activating a link or an icon correlating to the respective club or team. As clubs or teams are drafted, cost associated with each of the drafted clubs or teams is automatically deducted from the salary cap or budget 114 and the available budget (i.e., remaining salary) is calculated continuously, via the application 104. Preferably, available salary or budget is displayed on the user interface 105 as it is calculated and updated.

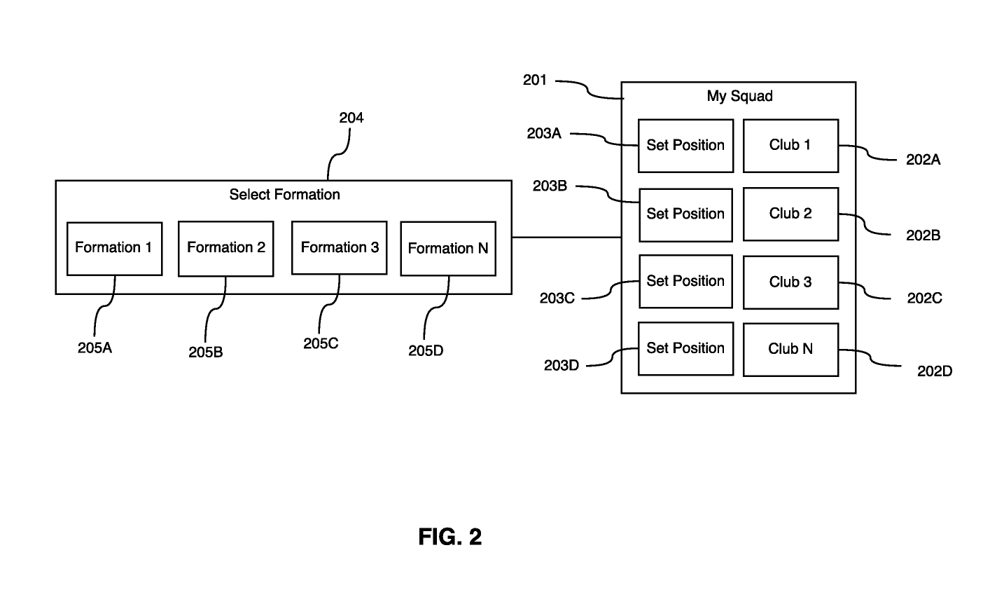

The drafted teams or clubs (e.g., a squad) are positioned according to a formation selected from a list of available formations displayed on the user interface 105. FIG. 2 shows a simplified view of an exemplary user interface for drafting and positioning selected teams. The application 104 (FIG. 1) provides a list of available formations 204 for the competition, in accordance with the competition parameters. In the illustrated embodiment, the available formations comprise formations 205A-206D, wherein these formations are represented as icons that can be activated upon selection. Only one of the formations 205A-206D can be selected at a time.

The user interface 105 (FIG. 1) of the application 104 (FIG. 1) further provides a list of teams or clubs 201 selected by the user for the competition. Each of the selected clubs 202A-202D is positioned in a lineup, and the user can select a position for each club 202A-202D by selecting an appropriate position for each club 202A-202D from the respective drop down menus 203A-203D.

Each formation correlates to a specific set of positions. Thus, the first formation 205A correlates to a first set of positions, the second formation 205B correlates to a second set of positions, the third formation 205C correlates to a third set of positions, and the fourth formation 205D correlates to a fourth set of positions. For example, in a game of fantasy soccer, the first formation 205A may comprise a 1-2-1 formation. The first formation 205A corresponds to the following set of positions: 1 Goalkeeper, 1 Defender, 2 Midfielders, and 1 Striker. Thus, if the user selects the 1-2-1 formation, the user can position 1 team as the Goalkeeper, 1 team as the Defender, 2 teams as the Midfielder, and 1 team as the Striker, assuming that a total of five clubs or teams were selected by the user. The user can set positions for each team using the drop down menus 203A-203D.

Additionally, as each position is selected for one or more teams, the drop down menus correlating to remaining teams (i.e., teams not yet positioned) are automatically configured to only show positions that are still available. For instance, if a first team were selected as a Goalkeeper, then the drop down menu for a second team to be positioned would be updated to show 1 Defender, 2 Midfielders, and 1 Striker. If the second team were selected as a Defender, then the drop down menu for a third team to be positioned would show 2 Midfielders and 1 Striker, and so on. In this way, the application 104 (FIG. 1) is configured to minimize or eliminate error when positioning the teams. Specifically, the application 104 (FIG. 1) prevents users from duplicating positions and ensures that all necessary positions are filled. Once the teams are positioned, the user can adjust or change the lineups as needed until the match starts. Once the match starts, the lineups set by each user in the match are locked.

Upon completing the draft, the application 104 (FIG. 1) prompts the user to pay the required entry fee, wherein the entry fee is payable with virtual currency or points. In some embodiments, virtual currency or points can be earned based on the user's account status and the amount of participation in competitions (i.e., users who frequently participate in competitions have more virtual currency or points). It is noted that virtual currency or points cannot be purchased or supplemented, for example, by paying a fee. The entry fee collected from each user is consolidated into a pile so that it can be allocated into winnings and losses after the competition is completed.

Some embodiments of the system further comprise a chat module 115 (FIG. 1) for allowing users to communicate with each other within the application 104 (FIG. 1). The chat module 115 (FIG. 1) is configured to enable the user to locate one or more other users, for example, via a search box, to initiate a real-time conversation. The chat module 115 (FIG. 1) is configured to allow users to have private chats as well as converse in a public chat room. For example, some embodiments of the chat module 115 (FIG. 1) may be specifically configured to provide a chat room for all users in a competition so as to allow the users to communicate during the match.

The server 106 (FIG. 1) is configured to receive actual live scores, results, and/or statistics from real games for each team that is in the fantasy competition. For example, the server 106 (FIG. 1) may be operatively connected to and/or receive feeds from third party sources (e.g., sports news networks). The live scores, results, and/or statistics 112 (FIG. 1) may be stored in the database 107 (FIG. 1) and used to calculate fantasy points for each team in the competition.

Some embodiments of the server 106 (FIG. 1) comprise a scoring module 108 (FIG. 1) for allocating points based on the parameters of the competition. In this regard, the scoring module 108 (FIG. 1) can automatically determine how many points to award to a drafted team for certain plays during the actual game. For example, the scoring module 108 (FIG. 1) is configured to allocate X number of points for each shot scored by a team, and Y number of points for each successful block by a team. Additionally, the scoring module 108 (FIG. 1) is configured to automatically award results points to teams or clubs for the actual results of the actual game. For instance, Z₁ number of points is awarded to a team or a club for a win, Z₂ number of points for a loss, and Z₃ number of points for a draw.

Moreover, some embodiments of the scoring module 108 (FIG. 1) are configured to apply scoring multipliers based on the position in which the user starts a team or a club in his or her lineup. In this regard, more points may be awarded to certain positions based on their performance in the competition. For example, a Striker in soccer is likely to be offensive and therefore offensive scoring statistics for a team that is positioned as a Striker may be multiplied at a greater factor than for a team that is in a position that is likely to be defensive. Conversely, a Goalkeeper in soccer is likely to be defensive and therefore defensive scoring statistics for a team that is positioned as a Goalkeeper may be multiplied at a greater factor than for a team that is in a position that is likely to be offensive.

Upon completion of the competition, the scoring module 108 (FIG. 1) consolidates the fantasy points for each team in the competition to determine the final competition standing for each user. For instance, if a user drafted five teams, the user's final competition standing is based upon the sum of the fantasy points for each of the five teams drafted by the user. The final competition standing for each user is used to automatically allocate winnings (i.e., entry fee in the form of virtual currency or points) and losses based on the prize structure or reward mechanism set for the competition, via the application 104 (FIG. 1).

Some embodiments of the user interface 105 (FIG. 1) further comprise a leaderboard 113 (FIG. 1) for displaying top performing users (i.e., usernames, other identifiers). The application 104 (FIG. 1) is configured to automatically update the leaderboard 113 (FIG. 1) after each competition to keep the data on the leaderboard 113 (FIG. 1) current. Any archived or outdated information relating to the leaderboard 113 (FIG. 1) is maintained in the database 107 (FIG. 1).

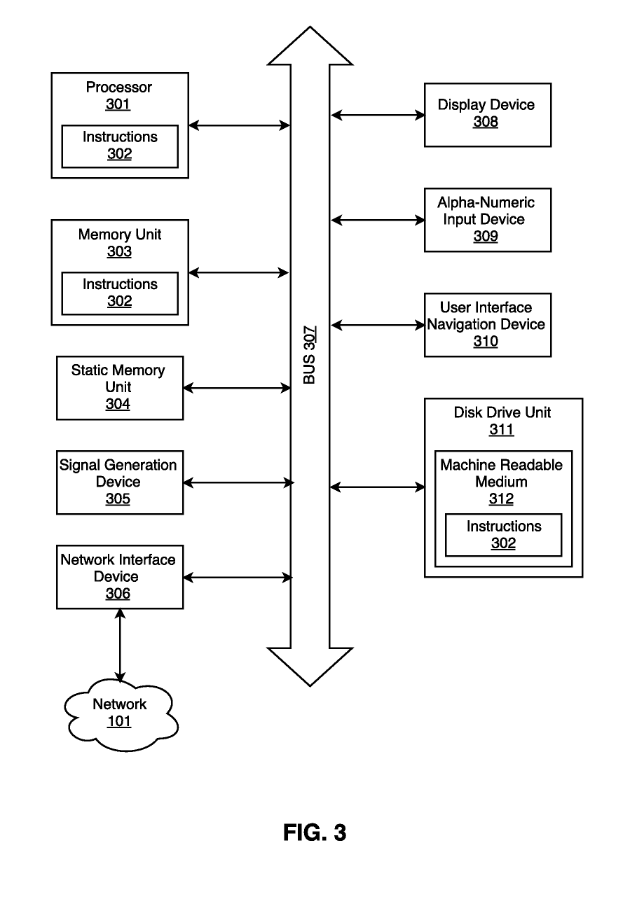

FIG. 3 shows a block diagram of an exemplary computer system within which instructions for causing the machine to perform any one or more of the methodologies discussed herein may be executed.

In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system includes a processor 301 (e.g., a central processing unit (CPU), a graphics processing unit (GPU), or both), a main memory unit 303, and a static memory unit 304, which communicate with each other via a BUS 307. The computer system may further include a display device 308 (e.g., a liquid crystal display (LCD) or a cathode ray tube (CRT)). The computer system also includes an alphanumeric input device 309 (e.g., a keyboard), a user interface (UI) navigation device 310 (e.g., a mouse), a disk drive unit 311, a signal generation device 305 (e.g., a speaker), and a network interface device 306. The computer system may also include other types of input devices such as an environmental input device that may provide a number of inputs describing the environment in which the computer system or another device exists, including, but not limited to, any of a Global Positioning System (GPS) receiver, a still photo or video camera, and an audio sensor (e.g., a microphone).

The disk drive unit 311 includes a machine-readable medium 312 on which is stored one or more sets of data structures and instructions 302 (e.g., software) embodying or utilized by any one or more of the methodologies or functions described herein. The instructions 302 may also reside, completely or at least partially, within the main memory unit 303 and/or within the processor 301 during execution thereof by the computer system. Thus, the main memory unit 303 and the processor 301 also constitute machine-readable media, depending upon embodiment.

While the machine-readable medium 312 is shown in an example embodiment to be a single medium, the term “machine-readable medium” may include a single medium or multiple media (e.g., a centralized or distributed database, and/or associated caches and servers) that store the one or more instructions 302 or data structures. The term “non-transitory machine-readable medium” shall also be taken to include any tangible medium that is capable of storing, encoding, or carrying instructions for execution by the machine and that cause the machine to perform any one or more of the methodologies of the present subject matter, or that is capable of storing, encoding, or carrying data structures utilized by or associated with such instructions. The term “non-transitory machine-readable medium” shall accordingly be taken to include, but not be limited to, solid-state memories, and optical and magnetic media. Specific examples of non-transitory machine-readable media include, but are not limited to, non-volatile memory, including by way of example, semiconductor memory devices (e.g., Erasable Programmable Read-Only Memory (EPROM), Electrically Erasable Programmable Read-Only Memory (EEPROM), and flash memory devices), magnetic disks such as internal hard disks and removable disks, magneto-optical disks, and CD-ROM and DVD-ROM disks.

The instructions 302 may further be transmitted or received over a computer network 101 (FIG. 1) using a transmission medium. The instructions 302 may be transmitted using the network interface device 306 and any one of a number of well-known transfer protocols (e.g., HTTP). Examples of communication networks include a local area network (LAN), a wide area network (WAN), the Internet, mobile telephone networks, Plain Old Telephone Service (POTS) networks, and wireless data networks (e.g., WiFi and WiMAX networks). The term “transmission medium” shall be taken to include any intangible medium that is capable of storing, encoding, or carrying instructions for execution by the machine, and includes digital or analog communications signals or other intangible media to facilitate communication of such software.

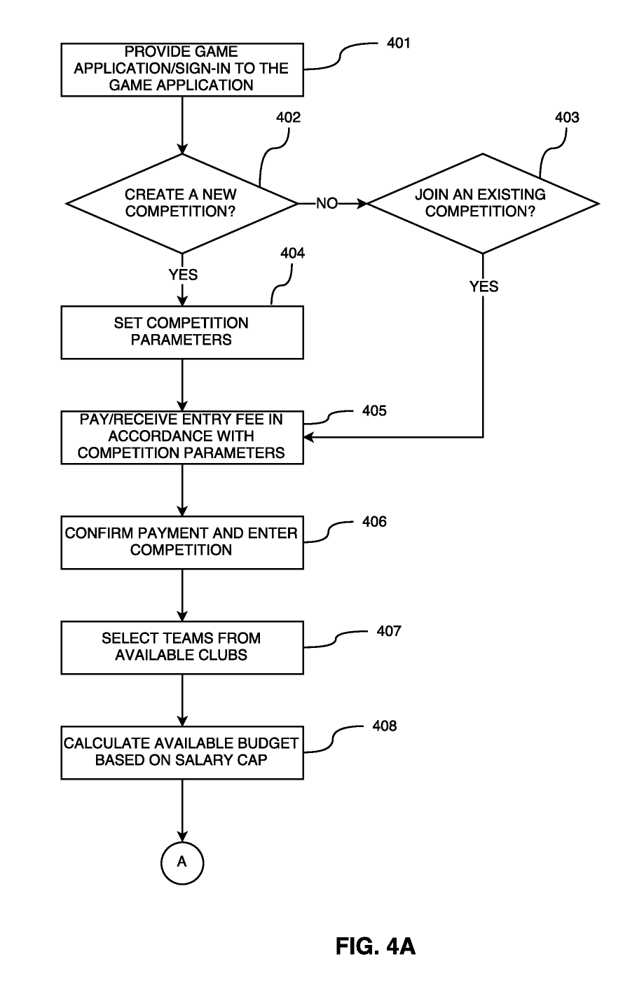

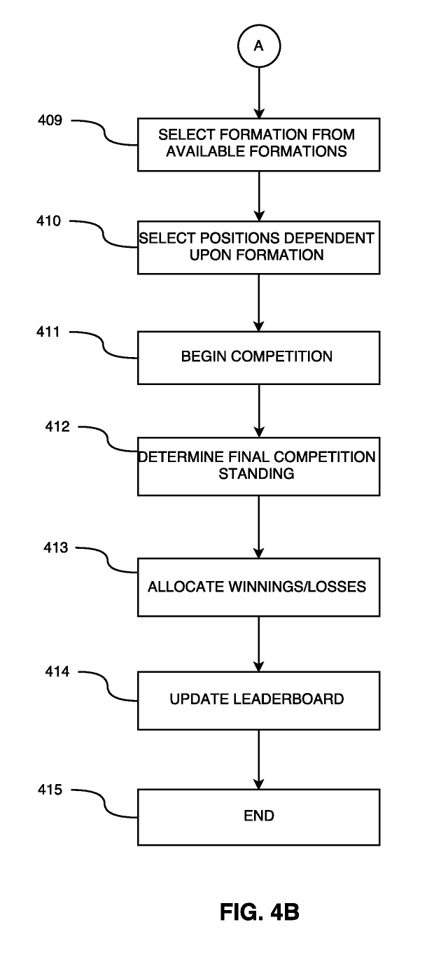

Reference is also made to FIGS. 4A and 4B, which schematically illustrate exemplary methods of the present invention. In some embodiments, one or more operations of FIGS. 4A and 4B may be performed by one or more elements of the system shown in FIGS. 1 through 3, e.g., user devices 102A-102C.

As indicated in block 401, the method begins with providing the game application 104 (FIG. 1) and signing into a user account via, for example, a website 103 (FIG. 1), a web application, a mobile application, a plug-in, or the like on a user device 102A-102C (FIG. 1). As indicated in block 402, the method includes creating a new competition or joining an existing competition as indicated in block 403. In order to create a new competition, one or more parameters (e.g., salary cap, minimum/maximum number of users in the competition, etc.) are set by a user (i.e., the creator) for the competition as indicated in block 404. In this regard, the game application 104 (FIG. 1) is configured to enable a user to select a league, name the league, set the duration of the competition (designate a minimum number of games), specify a budget restraint, set a maximum of players or participants, set a required entry fee, and set a prize structure. The competition may also be set or designated as a private competition or a private competition. If the competition is a private competition, the application 104 (FIG. 1) may automatically prompt the user to add or invite users to the competition.

To as indicated in block 405, the method further includes receiving entry fees paid from all participating users for the competition. Some embodiments include the step of automatically prompting users to pay the entry fee, wherein the entry fee amount is preset by the creator of the competition, as described above. The entry fees are paid within the application 104 (FIG. 1) with virtual currency. In this regard, the entry fees are withdrawn from each of the respective user accounts and all of the collected entry fees for the competition is set aside until the end of the competition when the winnings and losses are allocated.

As indicated in block 406, the method includes admitting users into the competition by associating or linking each user's account with the competition. In other words, as a user is admitted to competitions, the user is added onto the competition's roster. As a result, users are able to view a list of competitions to which they are participating, for example, on the user interface 105 (FIG. 1) (e.g., a dashboard or a homepage). In this regard, the user interface 105 (FIG. 1) may display the list of competitions in the order of the most recent competition to the least recent competition, or in another order as set by the user. Terminated competitions, including cancelled competitions, may be automatically archived or pushed down to the bottom of the list, depending upon embodiment.

As indicated in block 407, the method includes selecting teams from a list of available teams or clubs provided via the user interface 105 (FIG. 1). In this regard, the teams are selected in accordance with a budget restriction or salary cap. As each team is selected, the method includes calculating available budget, as indicated in block 408. In other words, as each team is selected, the cost of each of the respective teams is deducted from the salary cap. Conversely, as each team is de-selected, the method includes re-calculating the available budget by adding the cost of each of the respective teams back to the available budget.

As indicated in block 409, the method includes selecting a formation from a list of available formations. It is noted that the list of available formations depends on the type of fantasy sport played or as otherwise set in the competition's parameter. For instance, one set of formations is provided for soccer, and another set of formations is provided for basketball. Once a formation is selected, a set of positions that is associated with the formation is automatically populated by the application 104 (FIG. 1).

As indicated in block 410, the method includes selecting a position for each of the teams or clubs selected or drafted via drop down menus on the user interface 105 (FIG. 1). Optionally, the method further includes changing selected positions for one or more teams before the commencement of the competition. As indicated in block 411, the method includes commencing a competition. Once the competition starts, the team lineups are locked and users are no longer able to change lineups. Additionally, it is noted that the competition begins and concludes according to the time window specified in the parameter of the competition.

When the competition starts, the server 106 (FIG. 1) pulls live scores, statistics, and/or results from actual games for teams that are in the fantasy competition. The live scores, statistics, and/or results for teams are used to calculate fantasy points, via the scoring module 108 (FIG. 1), for each of the teams in the fantasy competition. As indicated in block 412, the method includes determining final competition standing for each user by combining the fantasy points earned by each of the user's teams in the competition and then comparing each user's fantasy points. Specifically, users with greater fantasy points are ranked higher than users with lower fantasy points in the final competition standing.

As indicated in block 413, the method includes allocating winnings and losses based on the prize structure or reward mechanism set for the competition. In this regard, users may be awarded via virtual currency or points based on their place in the final competition standing. For example, users who finish in the top half (i.e., top 50 percentile) of the competition can double their entry fee. Conversely, users who finish in the bottom half (i.e., lower 50 percentile) of the competition lose half of their entry fee. It is contemplated that any number of prize structure or reward mechanisms may be used.

As indicated in block 414, the method includes updating a leaderboard based on the users' performances from the fantasy competitions. The users who earn the most amount of virtual currency are moved toward the top of the leaderboard. Similarly, the users who earn the least amount of virtual currency, or the users who lost the most amount of virtual currency are moved toward the bottom of the leaderboard. The leaderboard may be updated on a regular interval or whenever competitions occur. In some embodiments, users at the top of the leaderboard may be recognized for setting a record. The user can enter multiple competitions at one time. If the user is no longer engaged in an active competition, the process is completed 415.

### A Scenario for Operation

The following may be considered a more concrete example of the functionality of the present game application. In this scenario, the functionality of the system, as more generally shown in FIGS. 1 through 4B, involves playing fan futsal via the game application 104 (FIG. 1).

Start five professional soccer clubs in each competition entered, wherein at least one club starts in each of the following position: 1) Goalkeeper (GK); 2) Defender (DF); 3) Midfielder (MD); 4) Striker (ST).

Goals For are worth one fantasy point. Results are worth three fantasy points for a win in an actual game, one fantasy point for a draw, and zero fantasy point for a loss. Goals allowed are scored in the following manner as shown in Table 1.

TABLE 1

| Goals Allowed | Fantasy Points |
|---|---|
| 0 | 3.0 |
| 1 | 1.5 |
| 2 | 0.5 |
| 3 | 0.0 |
| 4 | −0.5 |
| 5 | −1.0 |

Scoring multipliers are applied based on the position in which a fantasy owner starts a professional club in their lineup. Multipliers are applied to a club's Goals For and Goals Allowed based on the club's position in the lineup, as shown in Table 2.

TABLE 2

| Position | Goals For Multiplier | Goals Allowed Multiplier |
|---|---|---|
| GK | 0× | 6× |
| DF | 2× | 4× |
| MD | 4× | 2× |
| ST | 6× | 0× |

Results fantasy points (i.e., fantasy points derived from results of actual games) are not subject to any multipliers. Any club on a fantasy owner's team can be started in any position. Positions determine the scoring multipliers applied to a club's Goals For and Goals Allowed Eligible Formations, as shown in Table 3.

TABLE 3

| Formation | Position Breakdown |
|---|---|
| 1-2-1 | 1 GK, 1 DF, 2 MD, 1 ST |
| 1-1-2 | 1 GK, 1 DF, 1 MD, 2 ST |
| 1-0-3 | 1 GK, 1 DF, 3 ST |
| 2-1-1 | 1 GK, 2 DF, 1 MD, 1ST |
| 2-0-2 | 1 GK, 2 DF, 2 ST |
| 3-0-1 | 1 GK, 3 DF, 1 ST |

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A system for drafting and scoring a fantasy sports game, comprising:
a memory unit having computer-executable instructions stored thereon, and a processor operatively connected to said memory unit, said processor configured to execute said instructions comprising:
admitting a participating user into a competition by adding said user to a competition roster associated with said competition, wherein said competition is associated with parameters defined by a creator of said competition, wherein said parameters comprises entry fee and salary cap;
providing a list of available sports teams from which said user can draft at least one of said sports teams;
selecting a formation for said sports teams drafted in said competition, wherein said formation corresponds to a set of positions;
assigning one of said set of positions to one of said sports teams drafted for said competition until all of said sports teams drafted is assigned one of said set of positions;
receiving live statistics, scores, and results corresponding to said sports teams drafted for said competition in order to allocate fantasy points to said sports teams drafted for said competition;
combining said fantasy points for each of said sports teams drafted by said user in said competition;
determining a final competition standing of said user based on said fantasy points combined; and
allocating winnings or losses to said user, wherein said winnings or said losses are in form of a virtual currency collected as said entry fee.

2. The system of claim 1, wherein each of said sports teams is associated with a cost and said cost associated with each of said sports teams is deducted from said salary cap when each of said sports teams is drafted for said competition.

3. The system of claim 1, wherein said instructions further comprise updating a leaderboard based on said winnings or said losses allocated to said user.

4. The system of claim 1, wherein said instructions further comprise creating said competition and defining said parameters.

5. The system of claim 4, wherein said instructions further comprise inviting additional users if said parameters define that said competition is private.

6. The system of claim 1, wherein said instructions further comprise establishing communication between said user and additional users via a chat module.

7. A system for drafting and scoring a fantasy sports game, comprising:
a memory unit having computer-executable instructions stored thereon, and a processor operatively connected to said memory unit, said processor configured to execute said instructions for interacting with a user interface, said instructions comprising:
admitting a participating user into a competition by adding said user to a competition roster associated with said competition, wherein said competition is associated with parameters defined by a creator of said competition, wherein said parameters comprises entry fee and salary cap;
selecting at least one of said sports teams from a list of available sports teams provided on said user interface;
selecting a formation from a list of available formations on said user interface;
upon selecting said formation, selecting a position from a set of positions for each of said sports teams drafted in said competition;
assigning one of said set of positions to one of said sports teams drafted for said competition until all of said sports teams drafted is assigned one of said set of positions;
determining a final competition standing of said user based on fantasy points earned during said competition; and
allocating winnings or losses to said user, wherein said winnings or said losses are in form of a virtual currency collected as said entry fee.

8. The system of claim 7, wherein said set of positions is dependent upon a formation selected.

9. The system of claim 7, further comprising a server comprising a scoring module, said server configured to:
provide live scores, statistics, and results corresponding to said sports teams drafted for said competition in order to allocate said fantasy points to said sports teams drafted for said competition;
combining said fantasy points for each of said sports teams drafted by said user in said competition.

10. The system of claim 7, wherein said set of positions is provided via a drop down menu on said user interface, further wherein a different set of positions is provided in said drop down menu each time a different formation is selected.

11. The system of claim 10, wherein said drop down menu is configured to display remaining positions upon one of said set of positions being selected.

12. The system of claim 7, wherein said instructions further comprise displaying a leaderboard on said user interface.

13. The system of claim 7, wherein said instructions further comprise creating said competition and defining said parameters.

14. The system of claim 13, wherein said instructions further comprise inviting additional users if said parameters define that said competition is private.

15. A system for drafting and scoring a fantasy soccer game, comprising:
a memory unit having computer-executable instructions stored thereon, and a processor operatively connected to said memory unit, said processor configured to execute said instructions comprising:
creating a competition for a fantasy sport, wherein said competition is associated with a parameter defined by a creator of said competition, wherein said parameter comprises entry fee;
receiving said entry fee for said competition from a participating user, wherein said entry fee comprises virtual currency, further wherein paid entry fee is consolidated for allocation as winnings and losses;
selecting sports teams to form a squad in a lineup for said user, wherein said lineup specifies at least one of said sports teams to be designated as a goalkeeper, one of said sports team to be designated as a defender, and one of said sports team to be designated as a striker;
receiving live statistics, results, and scores for said sports teams to allocate fantasy points to each of said sports teams of said squad;
determining a user's final competition standing by combining said fantasy points for said squad entered in said competition;
allocating said winnings and said losses, wherein said entry fee is doubled for said winnings and said entry fee is halved for said losses;
updating a leaderboard based on said winnings and said losses allocated to said user.

16. The system of claim 15, wherein said winnings is allocated to said user if said fantasy points combined for said user is in top 50% of said competition.

17. The system of claim 15, wherein said losses is allocated to said user if said fantasy point combined is in bottom 50% of said competition.

18. The system of claim 15, wherein said squad further comprises a midfielder, an additional defender, or an additional striker.

19. The system of claim 15, wherein said instructions further comprising applying score multipliers based on a position in which said user starts said sports teams in said lineup, wherein said score multipliers apply to goals for and goals allowed.
